(19) United States
(12) Patent Application Publication
(10) Pub. No.: US 2011/0117298 A1
(43) Pub. Date: May 19, 2011

(54) RECORDING PAPER

(76) Inventors: Koki Hirayama, Yamaguchi (JP); Tadashi Fujimoto, Yamaguchi (JP)

(21) Appl. No.: 12/808,666

(22) PCT Filed: Nov. 14, 2008
(86) PCT No.: PCT/JP2008/070744

§ 371 Date: Jun. 16, 2010

(30) Foreign Application Priority Data
Dec. 17, 2007 (JP) 2007-324595
Nov. 4, 2008 (JP) 2008-282864

(51) Int. Cl. B41M 5/50

(52) U.S. Cl. 428/32.34

(57) ABSTRACT

To provide a printing sheet capable of vividly forming a fast image having rugged feeling and pictorial depth, featuring excellent weather-proof property, particularly, of yellow pigment.

[Means for Solution] A printing sheet comprising a substrate sheet in which semisolid shikkui (slaked-lime plaster) precursor particles are dispersed.

### TECHNICAL FIELD

This invention relates to a recording paper comprising a substrate sheet in which semisolid shikkui (slaked-lime plaster) precursor particles are dispersed.

### BACKGROUND ART

Accompanying the widespread use of personal computers and digital cameras in general households, ink-jet printers capable of printing vivid full-color images have now been widely used compounded by their low prices. As for the recording papers for printing used in the ink-jet printers, the ordinary fine papers and coated papers cannot be used from the standpoint of their properties. That is, the recording paper for printing requires such properties that the ink deposited on the paper surface is quickly absorbed therein, the ink droplets on the paper surface are suppressed from spreading or blurring, vivid image is formed, and the formed image features excellent fastness for extended periods of time without permitting color to be faded.

To impart such properties to the surfaces of the paper, it has been proposed to apply various inorganic solid substances onto the surfaces of the paper together with a binding agent, or to fill them in the paper. For example, a patent document 1 proposes the use of a synthetic silica or a salt thereof as the inorganic solid substance, a patent document 2 proposes the provision of a weak acid salt or oxide of a divalent metal such as magnesium or zinc as a coating layer on the surfaces of the paper, a patent document 3 proposes the provision of a coating layer containing natural or synthetic zeolite, diatomaceous earth or synthetic mica on the surfaces of the paper, patent documents 4 and 5 propose the provision of an ink-absorbing layer by using a white pigment such as clay, talc, calcium carbonate, kaolin, acid clay or active clay, and a patent document 6 proposes filling with porous spherical silicate particles.
Patent document 1: JP-A-57-157786
Patent document 2: JP-A-58-94491
Patent document 3: JP-A-59-68292
Patent document 4: JP-A-58-89391
Patent document 5: JP-A-59-95188
Patent document 6: JP-A-9-309265

### DISCLOSURE OF THE INVENTION

### Problems that the Invention is to Solve

With the above conventional recording papers inclusive of those used for a laser printer other than the ink-jet printers, however, the obtained images were all flat images like photographs, and pictorial and deep images could not be formed.

When the images were printed on the conventional recording papers, further, yellow color, in particular, lacked weather-proof property and after stored for extended periods of time, yellow color faded drastically. When a full-color image was printed, therefore, the color tone as a whole underwent changes being caused by the faded yellow color.

It is, therefore, an object of the present invention to provide a recording paper capable of vividly forming a fast image having rugged feeling and pictorial depth.

Another object of the invention is to provide a recording paper which, when an image is printed, features excellent weather-proof property, particularly, for yellow color, and is capable of maintaining stable color tone over extended periods of time not only when a yellow image is printed but also when a full-color image is printed.

A further object of the present invention is to provide a recording paper capable of forming the above images by printing by using an ink-jet printer.

### Means for Solving the Problems

By using a kneaded product of the slaked lime (calcium hydroxide) and water, the present inventors have attempted to disperse, in a recording paper, shikkui (slaked-lime plaster) precursor particles obtained by carbonating the slaked lime but before being completely carbonated, and have formed an image on the recording paper, the image having rugged feeling and depth. Namely, the inventors have newly discovered the fact that when an image was printed on the above recording paper, fading of, particularly, yellow color was effectively prevented, and have thus completed the invention.

That is, according to the present invention, there is provided a recording paper including a substrate sheet in which shikkui precursor particles are dispersed.

According to the present invention, it is desired that:

(1) The shikkui precursor particles are contained at a ratio of 2 to 90% by mass;
(2) The shikkui precursor particles have a carbonation ratio of not more than 70%;
(3) The shikkui precursor particles are contained in an amount of 5 to 500 parts by mass per 100 parts by mass of a filler other than the shikkui precursor particles blended in the substrate sheet;
(4) The filler other than the shikkui precursor particles is contained at a ratio of 1 to 50% by mass;
(5) The filler other than the shikkui precursor particles is one of silica, alumina, aluminum silicate, talc or kaolin, or a mixture of two or more thereof; and
(6) The recording paper is used as an ink-jet recording paper.

### Effects of the Invention

The recording paper of the present invention contains semisolid shikkui (slaked-lime plaster) precursor particles dispersed therein. The particles are rich in hydrophilic property and, therefore, an ink for forming image is allowed to deeply permeate therein. Besides, the particles are carbonated upon reacting with the carbonic acid gas in the air. Finally, therefore, the particles (slaked-lime plaster precursor particles) are solidified integrally together to form the shikkui (calcium carbonate). Therefore, the ink that has permeated into the recording paper is completely fixed by the shikkui, and the image formed on the recording paper features excellent fastness without almost permitting color to fade away even by the wiping attempt. Further, the recording paper in which the shikkui precursor particles are dispersed has a large degree of ruggedness on the surfaces thereof. Therefore, the image formed thereon exhibits rugged, deep and pictorial feeling close to wall images, and is of a nature quite different from the photographic images or the images printed by using ordinary printers. That is, with the conventional recording papers, though the layer of an inorganic solid substance is formed on the printing surfaces, the ruggedness is very fine on the surfaces which, therefore, are flat if viewed macroscopically. Therefore, though there can be formed images that are close to photographs, pictorial deep images cannot be formed. Further, even if ruggedness is formed on the surfaces by dispersing calcium carbonate particles and the like in the recording paper, the particles are not solidified integrally together. Therefore, the fastness of the image is poor, the calcium carbonate particles easily split off the surfaces, and color fades away by the wiping attempt.

In order for the above properties to be effectively exhibited, it is usually desired that the shikkui precursor particles are contained in an amount of 2 to 90% by mass. According to the present invention, the shikkui precursor particles are dispersed in the substrate sheet featuring excellent weather-proof property for yellow color particularly when an image is printed, without permitting yellow color to be faded even after stored for extended periods of time and, as a result, attaining such an advantage that the color tone of the image can be stably maintained for extended periods of time.

In the present invention, the phenomenon in that the weather-proof property of yellow pigment is improved by the use of the shikkui precursor particles was discovered through extensive experiment. Though the reasons have not been correctly clarified yet, the present inventors presume that the shikkui precursor particles including calcium hydroxide exhibit good affinity to the aqueous ink that contains an yellow pigment used for forming images. Therefore, if the aqueous ink containing the yellow pigment permeates therein, an alkali component elutes out into the aqueous ink from the shikkui precursor particles. Thereafter, in the course of carbonation, the alkali component solidifies so as to cover the yellow pigment eventually effectively suppressing the yellow pigment from being deteriorated by light or by oxidizing substances.

When the invention uses the shikkui precursor particles in order to improve the weather-proof property of yellow color in the printed image as described above, the shikkui precursor particles may be present near the surface on where the image is to be printed. The effect is exhibited even if the amount thereof is small. Therefore, the shikkui precursor particles may be dispersed in the substrate sheet in an amount of not less than 5 parts by mass per 100 parts by mass of other fillers blended in the substrate sheet.

The recording paper of the invention is very useful as a recording paper, particularly, for ink-jet printers, and pictorial images can also be printed even when the recording paper of the invention is used for printing photographic images using, for example, digital cameras. Further, the recording paper of the invention can be used not only for being printed but also for writing by using a writing brush with a black writing fluid.

### BEST MODE FOR CARRYING OUT THE INVENTION

The recording paper of the present invention contains the shikkui precursor particles dispersed in the substrate sheet, and is obtained by imbibing a slurry of the slaked lime (calcium hydroxide) in the substrate sheet followed by drying. That is, the particles of the slaked lame dispersed in the substrate sheet are gradually carbonated upon reacting with the carbonic acid gas in the air, turn into semisolid shikkui (slaked-lime plaster) precursor particles that are partly carbonated and are, finally, solidified integrally together to turn into the shikkui (calcium carbonate).

To imbibe the slurry of the slaked lime therein, the substrate sheet is formed by using a material that permits the slaked lime particles to be dispersed therein, such as various papers, woven fabrics comprising fibrous material such as glass fiber, vinylon fiber, polypropylene fiber, polyester fiber, polyethylene terephthalate fiber, acrylic fiber, aramide fiber or carbon fiber, or a laminated sheet thereof or a mixed sheet thereof. Generally, it is desired that the sheet is relatively porous so that the slurry of the slaked lime permeates therein, and has a voidage of, for example, not less than 30% and, particularly, not less than 40%. From the above point of view, it is desired to use a nonwoven fabric of the above fibrous material or a course paper (particularly, Japanese paper). A resin sheet formed by an ordinary sheet-forming method cannot permit the semisolid shikkui precursor particles to be dispersed therein, and cannot be used in the present invention.

The thickness of the substrate sheet can be set in a suitable range depending on the use. When used, for example, as a recording paper for the printers, the thickness is set in a range in which the paper can be passed through the printer.

The slurry of the slaked lime used for dispersing the shikkui precursor particles in the substrate sheet is a kneaded product of the slaked lime powder and water. Here, it is desired that the powder of the slaked lime is as fine as possible. That is, upon using the slurry in which the slaked lime powder of small particle sizes is dispersed, the slaked lime particles can be permeated even into the substrate sheet having a considerably small voidage. For instance, JP-A-2005-298732 and JP-A-2006-298732 disclose slurries in which the slaked lime powders having particle sizes of not larger than 5 μm and, particularly, not larger than 3 μm are dispersed. When these slurries are used, it is allowed to obtain recording papers in which the shikkui precursor particles are dispersed in sufficient amounts despite of using fine substrate sheets having a voidage of not more than 40% and, particularly, not more than 25%.

The concentration of the slaked lime in the slaked lime slurry is, usually, in a range of about 10 to about 70% by mass and, particularly, about 30 to about 60% by mass. If the concentration exceeds the above range, the viscosity of the slurry increases making it difficult to conduct the operation for permeating the slurry into the substrate sheet. If the concentration is lower than the above range, on the other hand, it becomes difficult to permeate the slaked lime particles into the substrate sheet in sufficient amounts.

It is desired that a polymer emulsion is dispersed as a binder material in the slurry. The polymer emulsion comprises an aqueous medium in which a monomer, an oligomer or a polymer thereof is dispersed like an aqueous emulsion of such a polymer as acrylic resin, vinyl acetate resin, polyurethane, styrene/butadiene rubber, etc. The emulsion permeates into the substrate sheet together with the dispersed particles of slaked lime. Upon removing water by the subsequent drying, the solid component of the emulsion remains in the substrate to improve the tenacity of the substrate sheet. Here, however, if the slurry is blended with the polymer emulsion in too large amounts, the slaked lime particles are hindered from permeating into the substrate sheet, and the shikkui precursor particles cannot be dispersed in sufficient amounts. Further, if the solid component of the polymer emulsion is dispersed in too large amounts in the substrate sheet, the painting material such as the ink permeates little into the recording paper, which causes the image to become obscure or causes the fastness of image to be deteriorated. It is, therefore, desired that the content of polymer emulsion in the slaked lime slurry is not more than 60 parts by mass and, particularly, in a range of 2 to 40 parts by mass calculated as the solid component per 100 parts by mass of the slaked lime to thereby improve the tenacity of the recording paper.

The slurry of the slaked lime can be permeated into the substrate sheet by dipping, roll-coating, spraying or application by using a brush. Usually, it is desired to employ the dipping since it makes it easy to adjust the amount of the slaked lime introduced into the substrate sheets by adjusting the dipping time. In order to obtain a recording paper in which the shikkui precursor particles are dispersed in only the vicinity of the printing surface, it is desired to employ the roll-coating. For example, when it is attempted to permeate the slurry of the slaked lime into the substrate sheet having a large voidage by dipping, the shikkui precursor particles can be dispersed in the whole substrate sheet. When it is attempted to permeate the slurry of the slaked lime into the substrate sheet having a small voidage by roll-coating, the shikkui precursor particles can be much dispersed on the surface side of the substrate sheet.

The substrate sheet after the slurry of the slaked lime has permeated therein, is dried to obtain the recording paper of the invention in which the slaked lime particles are dispersed, i.e., the shikkui precursor particles are dispersed. The recording paper is cut into a predetermined size and is put on sale. Depending upon the cases, the recording paper is wound as a roll of a long sheet and is stored; i.e., the recording paper is put on sale in the form of a roll. Or, the recording paper is unwound from the roll, cut into a predetermined size and is put on sale.

The recording paper of the invention contains the shikkui precursor particles in an amount of 2 to 90% by mass to offer the above-mentioned various advantages. From the standpoint of effectively preventing the removal of image as a result of wiping the surface, forming image having excellent fastness and forming deep image having rugged surface, in particular, it is desired that the recording paper of the invention contains the shikkui precursor particles in an amount of 20 to 90% by mass and, particularly, 30 to 80% by mass. If the amount is smaller than the above range, the shikkui precursor particles may fail to sufficiently exhibit the effect for maintaining the fastness of the image. Besides, if the amount of the shikkui precursor particles is small, the degree of ruggedness becomes small on the surface of the recording paper, the image printed thereon becomes smooth, and deep image will not be obtained. If the shikkui precursor particles are contained in amounts larger than the above range, on the other hand, tenacity of the recording paper is impaired and cracking may occur easily.

As described already, further, use of the shikkui precursor particles makes it possible to improve weather-proof property of yellow images. For this purpose, the shikkui precursor particles may be used in only small amounts. To improve the permeation of the printing ink, for instance, the substrate sheet may be filled with various fillers or, concretely, with amorphous silica, porous silicate, weakly acidic salt or oxide of a divalent metal such as magnesium or zinc, natural or synthetic zeolite, alumina, diatomaceous earth, synthetic mica, various clays, talc, calcium carbonate, kaolin, acidic clay or active clay in amounts of about 1 to 50% by mass per the whole amount of the substrate sheet as described in the above prior arts. By using the shikkui precursor particles in amounts of not less than 5 parts by mass and, particularly, not less than 20 parts by mass per 100 parts by mass of the above fillers, weather-proof property of yellow images can be markedly improved. In this case, if the amount of the shikkui precursor particles is less than the above range, it becomes difficult to effectively improve weather-proof property of yellow images. Further, even if used in amounts larger than the above range, weather-proof property of yellow images cannot be improved any further. Therefore, though the deepness can be imparted to the printed images, there is no need of using the shikkui precursor particles in amounts larger than the above range from the standpoint of simply improving weather-proof property of yellow images.

As the other fillers used in combination with the shikkui precursor particles, there can be, particularly preferably, used silica or alumina. Besides, the fillers can be permeated into the substrate sheet being mixed with the shikkui precursor particles, or can be permeated into the substrate sheet in the step of making the sheet.

As the yellow pigment used for forming yellow images of which the weather-proof property is improved upon being blended with the shikkui precursor particles according to the present invention, there can be used, for example, chrome yellow, zinc yellow, cadmium yellow, yellow iron oxide, mineral fast yellow, nickel titanium yellow, naples yellow, Naphthol Yellow S, Hansa Yellow G, Hansa Yellow 10G, Benzidine Yellow G, Benzidine Yellow GR, Quinoline Yellow Lake, Permanent Yellow NCG and Tartrazine Lake.

The slaked lime particles (shikkui precursor particles) dispersed in the substrate sheet as described above gradually react with the carbonic acid gas in the air and, finally, the particles are solidified integrally together to form the shikkui (calcium carbonate). In the present invention, however, the particles thereof have to be held in the semisolid state of before being completely solidified. If completely carbonated and solidified, however, the painting material such as the ink permeates little, fastness of the image decreases, and color easily fades away. According to the present invention, therefore, it is desired that the shikkui precursor particles are maintained in a state of being carbonated to a ratio of not more than 70% and, particularly, not more than 60%. This is because, as will be understood from the above description, if the image is formed by printing or the like, permeation of the image decreases with an increase in the ratio of carbonation. The ratio of carbonation represents the ratio of the weight of the calcium carbonate that is formed to the weight of the slaked lime that is introduced into the substrate sheet.

In the present invention, further, in order to prevent the shikkui precursor particles from undergoing the carbonation, it is desired that the recording paper is stored in a hermetically sealed manner until forming images. Concretely, the recording paper is stored in a state where a non-permeable and peelable protection sheet such as silicone paper, is stuck to both surfaces thereof or the recording paper is wrapped with a resin film and, at the time of forming images, the protection sheet or the resin film is removed away to use the recording paper.

Images can be formed by various means onto the recording paper of the invention in which the shikkui precursor particles have been dispersed. By using, for example, an ink in which a predetermined pigment or a dye is dispersed or dissolved, images of predetermined sizes can be continuously printed by gravure printing. Or, by using recording papers cut into a suitable size such as A4-size, the images can be printed thereon by using an ink-jet printer. Or, the images can be drawn by using a writing brush with a black writing fluid. In particular, the recording paper of the invention is most suited for drawing images by using a hydrophilic ink obtained by dissolving a water-soluble dye or dispersing a pigment in water (or a mixed solvent of water/alcohol) by using a surfactant, or by using a black writing fluid obtained by dispersing an ink stick in water. When the hydrophilic material is used, there is no blurring on the surface of the recording paper and a vivid image can be formed maintaining stability since the shikkui precursor particles are hydrophilic, too.

As described already, the recording paper on which the image is formed is left to stand in the atmosphere (usually, for about 0.5 to 30 days) whereby the shikkui precursor particles absorb the carbonic acid gas in the air, and are carbonated and solidified integrally together to turn into the shikkui (calcium carbonate). Therefore, the image permeates into the rugged and porous shikkui and is fixed thereto, and becomes like a wall picture featuring depth as compared to photographic images. Further, the formed image is excellent in fastness without permitting color to be faded away despite it is rubbed, and can be stably maintained for extended periods of time. Moreover, yellow image excels in weather-proof property and even after stored for extended periods of time, yellow color is effectively prevented from fading away, and the image stably maintains its color tone.

The recording paper of the present invention is particularly useful as a recording paper for the ink-jet printers. That is, when a digital image shot by using a digital camera is printed, too, a deep image resembling a fresco can be formed. Further, even when a full-color image is printed, the color tone of the full-color image can be stably maintained for extended periods of time.

### EXAMPLES

Excellent effects of the invention will now be described by the following Examples.

Testing methods and materials used in Examples were as described below.

### (1) Blurring Ratio of Image:

By using an ink-jet printer (Model PM-4000PX manufactured by Epson Co., with a water-soluble ink in which a pigment has been dispersed), a circle 10 cm in diameter was printed on the surfaces of the recording papers produced under the conditions shown in Examples and in Comparative Examples to obtain printed images. By using a color scanner available in the market, the thus obtained printed images (circular images) were read by a personal computer as digital images, and the number of pixels of a transferred color was measured by using an image-processing software, and was compared with the number of pixels of when the image was printed on a paper (common paper) dedicated to the ink-jet printer to calculate the blurring ratio (SR) according to the following formula,

SR=P1/P0
SR: Blurring ratio (−); usually not smaller than 1, which increases with an increase in the blurring ratio.
P1: Number of pixels (pixel) of the image printed on the recording paper produced under the conditions shown in Examples and Comparative Examples.
P0: Number of pixels (pixel) of the image printed on the paper dedicated to the ink-jet printer.

### (2) Abrasion Resistance Testing:

Abrasion when wet was tested in compliance with the JIS A 6921, and the degrees (classes) of abrasion were measured and evaluated in five steps.
Degrees of abrasion: Evaluated in five steps of class 1 to class 5; the class 5 represents the greatest degree of abrasion resistance.

### (3) Content of Inorganic Particles:

The content (% by weight) of inorganic particles was calculated in compliance with the following formula,

Content (% by weight) of inorganic particles=100×(P1−P0)/P1
P0: Weight of the substrate sheet (g/m²)
P1: Weight of the recording paper (g/m²)

### (4) Ratio of Carbonation:

Calcium hydroxide and calcium carbonate in the ornamental layer were determined by the ignition loss method, and the ratio of change (ratio of carbonation) of the calcium hydroxide into the calcium carbonate was calculated.

### (5) Yellow Color Weather-Proof Testing:

There were provided samples (A4-size) produced under the conditions of Examples and Comparative Examples. Next, by using the ink-jet printer (Model PM-4000PX manufactured by Epson Co., with a water-soluble ink in which a pigment has been dispersed), two pieces of each of the samples were printed with the yellow color in a size of 100 mm×100 mm. By using an ultraviolet ray-irradiating fluorescent lamp (“Neolumi-Super”, Model FL30SBL-360 manufactured by Mitsubishi Denki Co.), each piece of the samples was irradiated with an ultraviolet ray of an intensity of 500 μW/cm², and the remaining pieces were stored in a dark place.

The samples irradiated with ultraviolet rays for 3 months and the samples stored in the dark place for 3 months were taken out. By using a spectral color difference meter (handy color difference meter, model NF333, manufactured by Nihon Denshoku Kogyo Co.), according to JIS Z 8730, the samples were measured for their color differences (ΔE) in the yellow L*, a*, b* coloring system on the ultraviolet ray-irradiated portions and the non-irradiated portions.

The color difference (ΔE) increases with an increase in the change of color.

The following materials were used in Examples and Comparative Examples.

### (A) Substrate Sheets.

Glass fiber-mixed paper A:
“MPS-S5N” (trade name) produced by Hokuetsu Seishi Co.
Thickness: 0.32 mm
Average pore diameter: 12 μm
Voidage: 50%
Weight: 75 g/m²

Glass fiber-mixed paper B:
“MPS-03N” (trade name) produced by Hokuetsu Seishi Co.
Thickness: 0.35 mm
Average pore diameter: 4.5 μm
Voidage: 40%
Weight: 80 g/m²

### (B) Calcium Hydroxides.

Slaked lime A:
“High-Pure Slaked Lime CH” (trade name) produced by Ube Materials Co.
Average particle diameter; 5 μm

Slaked lime B:
Finely pulverized slaked lime (50% by weight aqueous slurry) produced by Tokuyama Co.
Average particle diameter; 0.5 μm

### (C) Inorganic Powders.

Calcium carbonate:
“WHITE 7” (trade name) produced by Yakusen Co.
Average particle diameter; about 8 μm

Calcium sulfate:
(Dihydrate, special grade chemical) produced by Wako Junyaku Co.

### (D) Aqueous Emulsion.

Polytron:
Acrylic copolymerized latex (“Polytron A 1480” produced by Asahi Kasei Kogyo Co.).
Solid content: 40% by weight

### (E) Alumina.

Boehmite•alumina (“CAM9010” produced by Sangoban Co.).
BET surface area; 120 m²/g
Length: about 90 nm

### Example 1

100 Parts by weight of the slaked lime A, 20 parts by weight of the aqueous emulsion and 60 parts by weight of water were mixed and kneaded together to obtain a slurry of the slaked lime. Next, the glass fiber-mixed paper A (300×200 mm) was dipped in the above slurry of the slaked lime for 3 minutes and was, thereafter, taken out, and was dried in a drying machine at 50° C. for 30 minutes to obtain a recording paper in which the slaked lime has been dispersed. The amount of the shikkui precursor particles in this case was 75% by mass and the ratio of carbonation was 20%.

Next, by using an ink-jet printer, a black circle 10 mm in diameter was printed on the surface of the recording paper and was dried in a room for 10 minutes. The blurring ratio of the thus obtained recording paper was 1.01. To carbonate the slaked lime (calcium hydroxide), further, the recording paper was left to stand in the room for 3 days and 30 days. The carbonation ratio, blurring ratio, degree of abrasion resistance and color difference in the yellow color weather-proof testing were as shown in Table 1.

### Example 2

A recording paper was prepared in the same manner as in Example 1 but changing the composition of the slurry of the slaked lime into 200 parts by weight of the slaked lime B and 20 parts by weight of the aqueous emulsion, and was evaluated in the same manner as in Example 1. The results were as shown in Table 1.

### Example 3

100 Parts by weight of the slaked lime B, 30 parts by weight of the aqueous emulsion and 5 parts by weight of the alumina were mixed and kneaded together to obtain a slurry of the slaked lime. Next, by using a bar coater, the slurry of the slaked lime was applied onto the surface of the glass fiber-mixed paper B (300×200 mm), and was dried in a drying machine at 50° C. for 30 minutes to obtain a recording paper in which the slaked lime has been dispersed. The amount of the shikkui precursor particles in this case was 10% by mass and the ratio of carbonation was 35%.

Next, the recording paper was evaluated in the same manner as in Example 1. The carbonation ratio, blurring ratio, degree of abrasion resistance and color difference in the yellow color weather-proof testing were as shown in Table 1.

### Comparative Examples 1 and 2

Recording papers were obtained through the same operation as in Example 1 but using the calcium carbonate or the calcium sulfate instead of the slaked lime. The obtained recording papers were evaluated for their blurring ratios, degrees of abrasion resistance and color differences in the yellow color weather-proof testing to obtain the results as shown in Table 1.

### Comparative Example 3

A recording paper was obtained through the same operation as in Example 3 but using the calcium carbonate instead of the slaked lime. The obtained recording paper was evaluated for its blurring ratio, degree of abrasion resistance and color differences in the yellow color weather-proof testing to obtain the results as shown in Table 1.

TABLE 1

| | Content of inorganic | | | | | Degree of | Color |
|---|---|---|---|---|---|---|---|
| | particles | | Carbonation | Carbonation | Blurring | abrasion | difference (ΔE) |
| | Inorganic | Content | time | ratio | ratio | resistance | in the weather- |
| | particles | (%) | (days) | (%) | (−) | (class) | proof testing |
| Ex. 1 | Shikkui | 75 | * | 20 | 1.01 | 4 | 3.1 |
| | precursor | | 3 | 55 | 1.09 | 5 | 4.2 |
| | | | 30 | 93 | 1.38 | 5 | 8.7 |
| Ex. 2 | Shikkui | 60 | * | 18 | 1.02 | 4 | 2.5 |
| | precursor | | 3 | 50 | 1.05 | 5 | 3.4 |
| | | | 30 | 89 | 1.31 | 5 | 8.1 |
| Ex. 3 | Shikkui | 10 | * | 35 | 1.03 | 4 | 3 |
| | precursor | | 3 | 65 | 1.07 | 4 | 4.1 |
| | | | 30 | 95 | 1.44 | 5 | 8.2 |
| Comp. | Calcium | 72 | — | — | 1.39 | 1 | 14.9 |
| Ex. 1 | carbonate | | | | | | |
| Comp. | Calcium | 70 | — | — | 1.30 | 2 | 11.4 |
| Ex. 2 | sulfate | | | | | | |
| Comp. | Calcium | 15 | — | — | 1.39 | 1 | 13.1 |
| Ex. 3 | carbonate | | | | | | |

*: immediately after preparation

1. A recording paper including a substrate sheet in which shikkui precursor particles are dispersed.

2. The recording paper according to claim 1, wherein said shikkui precursor particles are contained at a ratio of 2 to 90% by mass.

3. The recording paper according to claim 1, wherein said shikkui precursor particles have a carbonation ratio of not more than 70%.

4. The recording paper according to claim 2, wherein said precursor particles are contained in an amount of 5 to 500 parts by mass per 100 parts by mass of a filler other than the shikkui precursor particles blended in the substrate sheet.

5. The recording paper according to claim 2, wherein a filler other than the shikkui precursor particles is contained at a ratio of 1 to 50% by mass.

6. The recording paper according to claim 5, wherein said filler other than the shikkui precursor particles is one of silica, alumina, aluminum silicate, talc or kaolin, or a mixture of two or more thereof.

7. The recording paper according to claim 1, wherein said recording paper is used as an ink-jet recording paper.
